(19) United States
(12) Patent Application Publication
(10) Pub. No.: US 2006/0048122 A1
(43) Pub. Date: Mar. 2, 2006

(54) Method, system and computer program product for hierarchical loop optimization of machine executable code

(75) Inventors: Christopher Mark Barton, Edmonton (CA); Arie Tal, Toronto (CA)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/929,175

(22) Filed: Aug. 30, 2004

(51) Int. Cl. G06F 9/45

(52) U.S. Cl. 717/160; 717/151

(57) ABSTRACT

A common infrastructure for performing a wide variety of loop optimization transformations, and providing a set of high-level loop optimization related “building blocks” that considerably reduce the amount of code required for implementing loop optimizations. Compile-time performance is improved due to reducing the need to rebuild the control flow, where previously it was unavoidable. In addition, a system and method for implementing a wide variety of different loop optimizations using these loop optimization transformation tools is provided.

### CROSS REFERENCE TO RELATED APPLICATIONS

The present invention is related to the following applications, entitled “Generalized Index Set Splitting in Software Loops”, Ser. No. 10/864,257, filed on Dec. 19, 2003; and “A Method and System for Automatic Second-Order Predictive Commoning”, Ser. No. ______ (attorney docket # CA920040100US1) filed on even date hereof, both of which are hereby incorporated by reference.

### BACKGROUND OF THE INVENTION

1. Technical Field

The present invention relates to computer programming optimization techniques, and more particularly relates to compiler optimization techniques, and still more specifically relates to loop optimization techniques.

2. Description of Related Art

Computer programs are typically written by computer programmers in computer source code using high-level languages such as C, FORTRAN, or PASCAL. While programmers may easily understand such languages, modern computers are typically not able to directly read such languages. Source computer programs are typically translated into a machine language that a computer can understand. This translating process is performed by a compiler, which is a computer program that translates a source code program into object code. Object code is the corresponding machine language description of a source code-level computer program. Object code produced by compilers can often be made to execute faster by improving code execution paths. This improvement in code execution speed is called optimization. Compilers that apply such code-improving transformations when compiling source code to object code are called optimizing compilers. Certain types of optimizing compilers are generally known, such as that described in U.S. Pat. No. 6,077,314 entitled “Method of, System For, and Computer Program Product For Providing Improved Code Motion and Code Redundancy Removal Using Extended Global Value Numbering”, which is hereby incorporated by reference as background material.

A loop is a sequence of programming statements that are to be executed iteratively. Several programming languages have looping control commands such as “do”, “for”, “while”, and “repeat”. A loop may have multiple entry and exit points. Loops are well-known to computer programmers, and thus need not be further described herein to facilitate an understanding of the present invention.

Because current compiler technology is so reliable, some program developers have depended on the compilers' optimization features to clean up sloppily developed code. Some compilers can hide coding inefficiencies, but none can hide poorly designed code. For example, the following code sample shows an array being initialized:
int a=5;
int b=7;
int *acc[10];
for (i=0; i<10; i++) *acc[i]=a+b;
   Because a and b are invariant and do not change inside of the loop, their addition doesn't need to be performed for each loop iteration. Almost any good compiler optimizes the code. An optimizer moves the addition of a and b outside the loop, thus creating a more efficient loop. For example, the optimized code could look like the following:
int a=5;
int b=7;
int c=a+b;
int *acc[10];
for (i=0; i<10; i++) *acc[i] =c;
   This is a common and simple example of invariant code motion.

Loop optimizations tend to heavily rely on up-to-date Control Flow (and sometimes Data Flow) information. A classic loop optimization transformation would normally require information to perform a correctness test and an optimization profitability estimate. However, in the process of applying the transformation, that information quickly becomes invalid. For example, when replicating loops, no control flow information is available for the replica.

In addition, many loop optimization transformations have a lot in common. However, most transformations are coded using very low-level, non-loop optimization specific “building blocks”, and require a lot of repetitive (or slightly repetitive), manual work.

It would thus be advantageous to provide a set of loop optimization tools that can be used as building blocks for performing complex loop optimization techniques for use by an optimizing compiler or other computer program analysis tools or code generators.

### SUMMARY OF THE INVENTION

The present invention is directed to a common infrastructure for performing a wide variety of loop optimization transformations, and provides a set of high-level loop optimization related “building blocks” that considerably reduce the amount of code required for implementing loop optimizations. Compile-time performance is also improved due to reducing the need to rebuild the control flow, where previously it was unavoidable.

The present invention is also directed to a system and method for implementing a wide variety of different loop optimizations using these loop optimization transformation tools.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 depicts the high level environment for generating machine executable code from source code.

FIG. 2 depicts the internal functional operation of a code optimizer.

FIG. 3 depicts the internal functional operation of a compiler back-end process.

FIG. 4 depicts a traditional loop optimization technique.

FIG. 5 depicts an improved loop optimization technique using loop data objects.

### DETAILED DESCRIPTION OF THE PREFERRED EMBODIMENT

The Loop Tools described herein are a powerful set of high-level loop optimization oriented tools. These tools were designed and developed with a goal to be applicable to as wide a variety of loop optimizations as possible, while preserving the simplicity of the interface and the combination of the tools together. The Loop Tools rely heavily on the loop data framework of loop data objects, which records flow graph information about loops. By making the tools update the loop data objects when transforming loops, the data contained in these objects remains valid even though the flow graph may no longer be valid. Some of these Loop Tools can be used in other types of optimizations such as control flow (proving a branch is never taken) or data flow, but the primary focus on the present invention is on the benefit with respect to loop optimization.

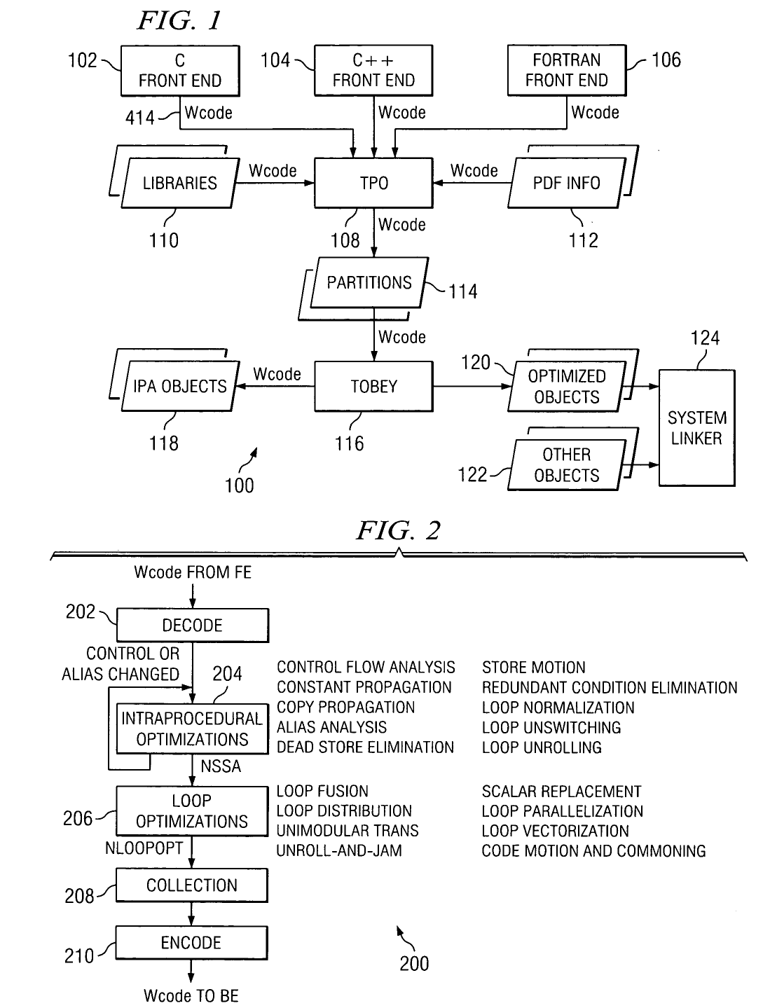

Before describing the Loop Tools in detail, a general discussion of the programming environment that the Loop Tools are used in is in order. Referring to FIG. 1, the overall compilation environment is shown at 100. An optimizer, for example the Toronto Portable Optimizer (TPO) 108, has as input a W-code stream generated from one of various compiler front-ends, such as C Front End 102, C++ Front End 104, or Fortran Front End 106. Other inputs to the TPO 108 may include a W-code stream from one of Libraries 110 and a W-code stream from Profile-Directed Feedback (PDF) Information 112. The outputs from the TPO Optimizer (to be further described herein) are W-code partitions, such as Partitions 114, which are then read by a back-end compiler process, such as TOBEY 116 (to be further described herein). The output of TOBEY 116 is a set of optimized objects 120 which, along with other objects 122, are fed into a system linker 124 for generation of the resulting machine-executable code (not shown). Optionally, if an inter-procedural analysis (IPA) option is enabled for the compiler upon compiler invocation, IPA objects 118 are generated, which is information about all of the compilation units in the program and which can be used to perform further program optimization during a subsequent pass of the compiler.

Turning now to FIG. 2, there is shown at 200 a block diagram of the internal operation of TPO block 108 of FIG. 1. W-code from a Front End (FE) such as Front End 102, 104 or 106 of FIG. 1 is input into a decode block 202 for decoding. Intra-procedural optimizations are performed at 204, and include such things as control flow analysis, constant propagation, copy propagation, alias analysis, dead store elimination, store motion, redundant condition elimination, loop normalization, loop unswitching and loop unrolling. Loop optimizations occur at block 206, including loop fusion, loop distribution, unimodular trans, unroll-and-jam, scalar replacement, loop parallelization, loop vectorization, and code motion and commoning. Collection is performed at 208, and the output of collection block 208 is input to an encode block 210, which generates the W-code partitions to be input into a back-end (BE) process such as TOBEY 116 shown in FIG. 1.

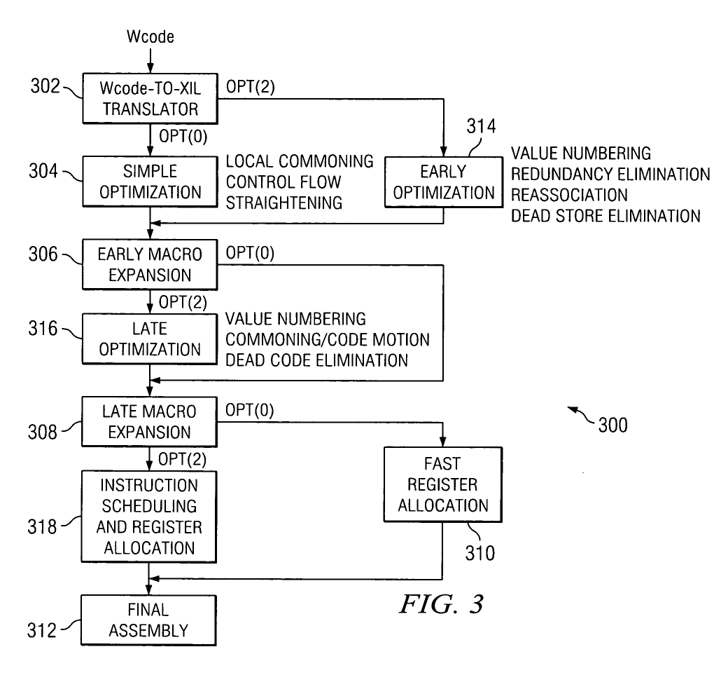

Turning now to FIG. 3, there is depicted a block diagram of the internal processing within a back-end compiler process, such as TOBEY 116 shown in FIG. 1. W-code partitions output from TPO 108 (FIG. 1) are input into a W-code to XIL translator 302. Depending on the compiler options that have been set (either OPT(O) or OPT(2)), either a simple optimization is performed at 304 (including optimization techniques of local commoning and control flow straightening) or alternatively for OPT(2), an early optimization is performed at 314 (including optimization techniques of value numbering, redundancy elimination, re-association and dead store elimination). After either simple optimization has been performed at 304, or early optimization has been performed at 314, control then passes to the early macro expansion block 306. Then, if OPT(O) has been selected, process flow proceeds to block 308 where late macro expansion is performed. If however, OPT(2) has been selected, process flow first proceeds to late optimization block 316 prior to the late macro expansion 308. The late optimization block 316 performs such things as value numbering, commoning/code motion and dead code elimination. When exiting from late macro expansion block 308, either a fast register allocation is performed by block 310 (if OPT(0) has been selected) or instruction scheduling and register allocation are performed at 318. In either event, processing then continues to block 312 for final assembly of optimized objects 120 (FIG. 1).

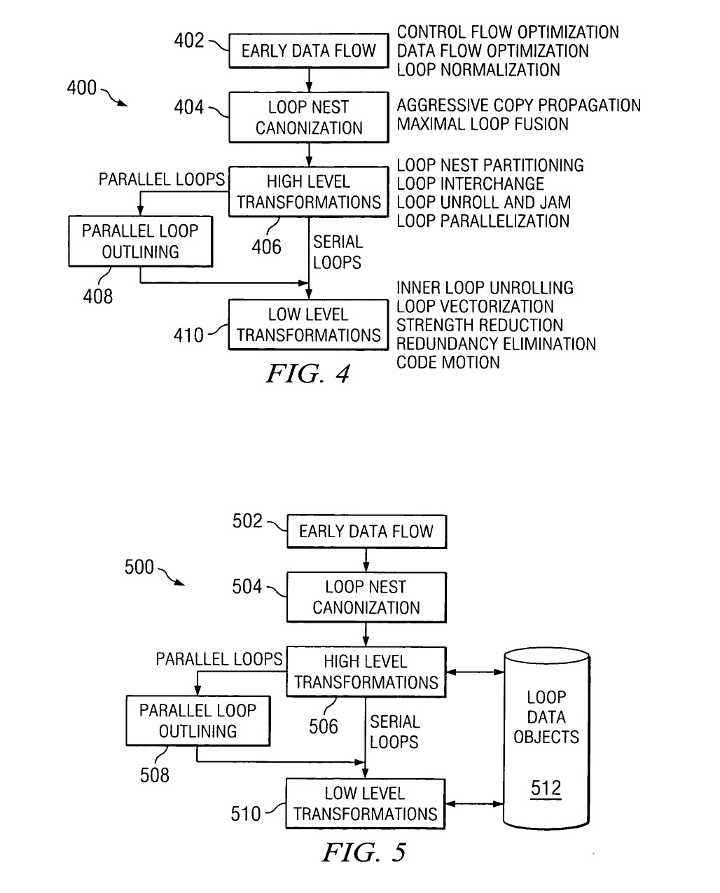

A high level block diagram demonstrating an example of high level optimizations that are performed by a compiler is shown at 400 in FIG. 4. Early data flow is analyzed at block 402, where control flow optimization, data flow optimization and loop normalization occurs. Processing then continues to block 404 for loop nest canonization, which performs aggressive copy propagation and maximum loop fusion. High level loop transformations are then performed at block 406, including loop nesting partitioning, loop interchange, loop unroll and jam, and loop parallelization. Then, for parallel loops, processing proceeds to block 408 to perform parallel loop outlining. Then, processing continues to block 410 to perform low level transformations such as inner loop unrolling, loop vectorization, strength reduction, redundancy elimination and code motion. For serial loops, processing proceeds directly from block 406 to 410. The loop optimization described with respect to FIG. 4 is a traditional form of loop optimization and need not be described in detail to fully understand the present invention.

FIG. 4 contains several optimizations that deal specifically with loops (all optimizations in 406, and inner loop unrolling and loop vectorization in 410). All of these optimizations work on loops and thus extensively use the internal loop structures in the compiler. They also require control and data flow information available from other internal data structures in the compiler. During an optimization these internal data structures may become invalid and need to be rebuilt to be used. However, rebuilding these data structures is time consuming and should be avoided as much as possible. The loop data object as further described below advantageously provides a container that stores relevant information about loops. At the beginning of a loop optimization, the loop data object is initialized using up-to-date control and data flow information. As the optimization analyses and transforms loops, the loop data objects are used to access the relevant information.

The internal representation of a loop consists of several parts. These parts include a prolog, which is the part of the loop that is executed once, prior to the body of the loop (i.e. the initialization of the induction variable), an epilog which is the part of the loop that is executed once after the body of the loop has finished executing (i.e. the terminating condition of the loop has become true), a guard which prevents the entire loop (prolog, body and epilog) from executing if some condition is not met. The loop also contains hooks into the statements of the loop. These are referred to as the first statement and last statements in the loop, or the BodyBegin and BodyEnd of the loop. Every counted loop has an associated induction variable, which is modified inside the loop and used in the condition to test the terminating condition of the loop. Every counted loop also has a bump statement, which is the increment of the induction variable.

The present invention is directed to an improved loop optimization technique which improves upon the loop optimization shown and described above with respect to FIG. 4. In particular, a well-defined set of low-level loop tools are provided to perform basic loop manipulations. These loop manipulation tools have been generalized such that they can be used by a plurality of higher-level optimization techniques in different contexts to achieve the overall desired result of loop optimization. As shown at 500 in FIG. 5, early data flow is analyzed at block 502, where control flow optimization, data flow optimization and loop normalization occurs in similar fashion to that described above with respect to block 402 in FIG. 4. Processing then continues to block 504 for loop nest canonization, which performs aggressive copy propagation and maximum loop fusion in similar fashion to that described above with respect to block 404 in FIG. 4. High level loop transformations are then performed at block 506. However, per the present invention and as further described below, loop data objects 512 are used to maintain data pertaining to the loops. For parallel loops, processing proceeds to block 508 to perform parallel loop outlining. Then, processing continues to block 510 to perform low level transformations. For serial loops, processing proceeds directly from block 506 to 510. Here again, loop data objects 512 are used to maintain data pertaining to the loops in accordance with the present invention.

One internal representation used in TPO (FIG. 1, element 108) is a list of statements. Statements represent executable instructions as well as jump labels. Statements are represented using a double-linked list. Every statement has a NextStatement field, which points to the next statement to be executed and a PreviousStatement field that points to the previous statement executed. Every statement has an expression associated with it, which is a high level representation of the instructions to execute for that statement (e.g. a=b+c).

A description of these low-level tools is now in order. The following describes all the tools in the “Loop Tools” set, divided into a few main categories. After each command/tool, a summary of the function provided by the command/tool is given, followed by a text description if appropriate. For most of the commands/tools, pseudo-code is then listed and described for implementing the commands/tools.

Loop Manipulation, Replication and Creation Tools

replicateLoop—Replicate a loop

This method replicates a loop to a given location (where to), and returns a LoopData object that has pointers to all the recorded statement pointers from the original LoopData parameter, pointing to statements in the replica.

replicateLoop(LoopData loop, Location loc)
1. newLoopData←new LoopData
2. newLoopData←loop
3. loc.nextStatement←newLoopData
4. return newLoopData
Step 1 creates a new loop data object that has no fields initialized. Step 2 copies all of the fields in the input loop data object (loop) into the new loop data object. Step 3 inserts the new loop data object into the instruction stream, immediately after loc. Step 4 returns the new loop data object.
   versionLoop—Create two versions of a loop, switched by a condition

Example:
VersionData*versionData=versionLoop(LoopData(loopId, LoopData::kLoopAll), condExpr);

Given a loopId and condExpr, versionLoop( ) will create two versions of the loop indicated by loopId, where a conditional expression (condExpr) switches between the two version. The resulting code would look like:

```
if (condExpr) {
  Original version of the loop ;
} else {
  Replicated version of the loop ;
}
```

versionData contains some important recorded information for making this transformation useful. For example, versionData contains a pointer to the conditional statement, which can be used to add some more elaborate computations just before the condition (if needed for computing an elaborate condition).

versionData also contains a pointer to a new LoopData instance representing the replicated loop. All the data that was recorded from the original loop is mapped to the replica in the new LoopData instance. The basic block indexes such as LoopData::mHeader, LoopData::mGuard, etc. are set to 0, since the control flow does not get built for the replicated loop.

LoopData is used to record as much information on a loop as needed. The LoopData for the replicated version contains all same information (other than basic block indexes) with all the right pointers to statements, without a need to rebuild the control flow.

Parameters:

loopData—A LoopData recorded for the original loop.

cond—An ExpressionNode that will serve as the switching condition.

Returns:

A VersionData object that describes the replicated loop (though a LoopData object), and some information about the location of the conditional statement, etc.

versionLoop(LoopData loop, Statement cond)
1. versionData←new VersionData
2. newLoopLoc←condExpr.nextStatement
3. newLoopData←replicateLoop(loop, newLoopLoc)
4. cond.nextStatement←loop
5. versionData.condStmt←cond
6. versionData.newLoop←newLoopData
7. return versionData
Step 1 creates a new versionData object that will be populated by the versionLoop tool and returned. Step 2 determines the location where the new, replicated loop will be placed (the else statement in the example above). Step 3 creates a replica of the original loop, using the replicateLoop tool described above. Step 4 places the original loop under the provided condition statement. Steps 5 and 6 record relevant information in the version data object and step 7 returns the version data object.
   splitLoop—Split a loop's index range using a split point expression, resulting in two consecutive loops.

This method splits a loop using a given index expression, and returns a LoopData object containing pointers to statements in the second part loop (the newly created loop). The LoopData of the original loop is updated accordingly. The new pointers are determined by the ones available in the provided loopData object, since a one-to-one mapping is performed by replicateLoop between the original loop's statements and the replica.

Note that the prolog and epilog of the original loop will be peeled off the loop prior to splitting it.

Example:

```
Before:
  i=0;
  while (i < 100) {
    loop code
    i += 1
  }
```

After calling splitLoop with split point expression i<50:

```
i=0;
while (i < 50) {
  loop code
  i += 1
}
while (i < 100) {
  loop code
  i += 1
}
```

splitLoop(LoopData loop, Expression splitPoint)
1. peelProlog (loop)
2. peelEpilog (loop)
3. newLoop←new LoopData
4. newLoop←loop
5. modifyUpperBound(loop, splitPoint)
6. modifyLowerBound(newLoop, splitPoint)
7. loop. nextStatement (newLoop)
8. return newLoop
Step 1 peels the prolog from the loop. Step 2 peels the epilog from the loop. Step 3 creates a new loop data object. Step 4 copies the original loop data into the new loop data object. Step 5 modifies the upper bound of the original loop to the provided split point (modifyUpperBound described below). Step 6 modifies the lower bound of the new loop to the provided split point (modifyLowerBound described below). Step 7 puts the new loop into the instruction stream, after the original loop. Finally, step 8 returns the new loop.
   createEmptyLoop—Create an empty normalized loop.

This method creates an empty loop, returning a LoopData object with all the pointers set correctly so that the “blanks” can be then easily filled in.

Parameters:

guard—A guard expression (e.g. 0<n).

upperBound—An upper bound expression (e.g. n)

where—A statement, after which the loop will be created. If not specified, loop will not be linked into statement list.

civId—The CIV to be used in the loop (a new one is created if none specified).

useFJPGuard—Specify whether the loop's guard should use a false jump or true jump instruction.

Returns:

A LoopData object that describes the created loop.

createEmptyLoop(Expression guard, Expression upperBound, Statement where, CIV civ)
1. emptyLoop←new LoopData
2. emptyLoop.guard←guard
3. emptyLoop.civ←civ.
4. modifyUpperBound(emptyLoop, upperBound)
5. where.NextStatement.PreviousStatement←emptyLoop.LastStatement
6. emptyLoop.LastStatement.NextStatement←where.NextStatment
7. emptyLoop.FirstStatement.PreviousStatement←where
8. where.NextStatement←emptyLoop.FirstStatement
9. return emptyLoop
Step 1 creates an empty loop data object. Step 2 sets the guard of the empty loop to the specified guard. Step 3 sets the controlling induction variable of the empty loop to the specified CIV. Step 4 sets the upper bound of the empty loop to the specified upper bound (modifyUpperBound described below). Steps 5 and 6 add the last statement of the empty loop to the statement list. Steps 7 and 8 add the first statement of the empty loop to the statement list. Step 9 returns the new, empty loop data object.
   removeLoop—Remove a loop's control structure and body.

This method is used to remove an entire loop body from the program. The loop is removed from all control flow and data flow structures, as well as additional structures that contain information about loops.

peelProlog—Make the prolog of a loop a separate entity (a guarded block).

The loop prolog is the part of the loop that is executed once, prior to the execution of the loop body (e.g. the initialization of the induction variable)

The prolog will be guarded by the same guard as the loop. There is no check that the prolog modifies anything that is referred to by the guard.

This will leave only the induction variable initializer within the loop prolog.

The PrologBegin and PrologEnd statement pointers of the LoopData object will be modified to reflect the change.

peelProlog(LoopData loop)
1. newGuard←Copy(loop.Guard)
2. newGuard.PreviousStatement←loop.Guard.PreviousStatement
3. loop.Guard.PreviousStatement.NextStatement ←newGuard
4. loop.PrologBegin.PreviousStatement←newGuard
5. newGuard.NextStatement←loop.PrologBegin
6. loop.PrologBegin.PreviousStatement.NextStatement ←loop.PrologEnd.NextStatement
7. loop.PrologEnd.NextStatement.PreviousStatement←loop.PrologBegin.PreviousStatement
8. loop.PrologEnd.NextStatement←loop.Guard
9. loop.Guard.PreviousStatement←loop.PrologEnd
Step 1 creates a new guard statement to guard the peeled prolog. The new guard is a copy of the loop's guard statement. Steps 2 and 3 add the new guard to the statement list, immediately before the loop's guard statement. Steps 4 and 5 move the first statement of the prolog immediately after the new guard statement. Steps 6 and 7 remove the loop prolog from the loop data object. Steps 8 and 9 moves the last statement in the prolog to immediately before the loop guard.
   peelEpilog—Make the epilog of a loop a separate entity (a guarded block).

The loop epilog is the part of the loop that is executed once, after all iterations of the loop body have executed.

The epilog will be guarded by the same guard as the loop.

There is no check that the epilog modifies anything that is referred to by the guard.

The EpilogBegin, EpilogEnd statement pointers of the LoopData object will be set to NULL. The Epilog basic block index will be set to 0.

peelEpilog(LoopData loop)
1. newGuard←Copy(loop.Guard)
2. newGuard.PreviousStatement←loop.Guard.PreviousStatement
3. loop.Guard.PreviousStatement.NextStatement←newGuard
4. loop.EpilogBegin.PreviousStatement←newGuard
5. newGuard.NextStatement←loop.EpilogBegin
6. loop.EpilogBegin.PreviousStatement.NextStatemet←loop.EpilogEnd.NextStatement
7. loop.EpilogEnd.NextStatement.PreviousStatement←loop.PrologBegin.PreviousStatement
8. loop.EpilogEnd.NextStatement←loop.Guard
9. loop.Guard.PreviousStatement←loop.PrologEnd
The peelEpilog pseudo-code works exactly the same as the peelprolog pseudo-code, working on the epilog of the loop instead of the prolog.
   Link—Add a loop to the control flow at a given position.

This method can be used with Unlink to move a loop from one location to another. It can also be used to insert a new loop (created using createEmptyLoop) that was not added to the statement list when it was created.

Parameters:

loopData—A LoopData object recorded for the loop to link.

pos—a statement node pointer after which to link the loop

Link(LoopData loop, Position pos)

1. loop.LastStatement.NextStatement←pos.NextStatement
2. pos.NextStatement.PreviousStatement←loop.LastStatement
3. pos.NextStatement←loop.FirstStatement
4. loop.FirstStatement.PreviousStatement←pos

The list of statements that contains the loop can be viewed as a double-linked list. To this end, inserting a loop requires the setting of the next and previous fields in two separate statements. That is, to insert a loop into a list of statements, after a specified position pos, the next field of pos must be set to point to the first statement in the loop. Similarily, the previous field in the statement immediately following pos in the original list must be set to point to the last statement in the loop.

In the pseudo-code above, FirstStatement and LastStatement refer to the first and last executable statement in the LoopData object respectively. NextStatement and PreviousStatement refer to the links in the statement list, pointing to the next statement and the previous statement in the list respectively. Steps 1 and 2 add the last executable statement in the LoopData object by updating the links of the affected statements. Steps 3 and 4 add the first executable statement in the LoopData object by updating the links of the affected statements.

Unlink—Remove a loop from the control flow.

This method can be used with the Link method to move entire loops from position to position in the control flow.

The loop table is not affected by this method and the statement nodes are preserved (contrary to removeLoop).

Unlink(LoopData loop)

1. loop.FirstStatement.PreviousStatement.NextStatement←loop.LastStatement.NextStatement
2. loop.LastStatement.NextStatement.PreviousStatement←loop.FirstStatement.PreviousStatement
   blockLoop—Block a loop using the given blocking factor at the given position.

Loop blocking is a transformation that divides a loop's iteration space into equally sized strips (strip-mining).

In addition, the controlling loop (the loop controlling the strips) can be placed at any outer level in the loop nest (i.e. interchange).

The end result is that a loop gets ‘blocked’ at some outer nest level. A combination of blocking loops can create a ‘loop tiling’ effect.

Parameters:

which—A LoopData object recorded for the loop to block.

where—A LoopData object recorded for the loop around which the blocking loop (the controlling loop) would be created.

blockingFactor—an expression containing the blocking factor (strip size).

blockLoop(LoopData which, LoopData where, BlockingFactor factor)

1. newCIV←new CIV
2. blockingUB←(which.UpperBound+(factor-1))/factor
3. blockingLoop←createEmptyLoop(which.Guard, blockingUB, where.Guard.PreviousStatement, newCIV)
4. Unlink(where)
5. Link(where, blockingLoop.BodyBegin)
6. modifyLowerBound(which, factor*newCIV)
7. newUB←min(factor*newCIV+factor, which.UpperBound)
8. modifyUpperBound(which, newUB
9. modifyGuard(which, newUB<newCIV)
10. return blockingLoop
Step 1 creates a new induction variable to be used in the blocked loop. Step 2 computes the upper bound that will be used in the new (blocked) loop. Step 3 creates a new, empty loop. This loop will have the same guard as the original (which) loop, the upper bound computed in step 2, and will be placed immediately before the where loop. Steps 4 and 5 move the body of the where loop into the new (blocked) loop. Step 6 modifies the lower bound of the new loop. Steps 7 and 8 calculate and set the upper bound of the new loop, respectively. Step 9 modifies the guard of the original loop. Step 10 returns the new (blocked) loop.
   Loop Control Structure Modifiers
   removeLoopControlStructure—Remove loop control structure—convert a loop structure into a guard.

This method is useful for converting single iteration loops into non-loops. There is no check to verify that the loop is a single iteration loop, since it may some time not be easy to prove that using the lowerBound, upperBound expressions (especially if there are min/max operations within these expression—see DoIndexSetSplitting). Therefore, this method only provides the “mechanics” of removing the loop control structures for a given loop.

removeLoopControlStructure(LoopData loop)

1. loop.LatchBranch←NULL
2. loop.LoopLabel←NULL
3. foldGuard (loop)
4. Remove loop from related data structures
Step 1 sets the latch branch of the specified loop to be NULL (thereby removing it). Step 2 sets the loop label of the specified loop to NULL. Step 3 attempts to remove the guard protecting the specified loop. Finally, all records of the specified loop in other internal data structures are removed.
   modifyLowerBound—Modify the induction variable initializer for the loop.
   Parameters:

loopData—A LoopData recorded for the loop.

lowerBound—A lower bound expression. Note that if lowerBound is 0, the loop is guarded and the bumper is normalized, then the loop would be marked as lower bound normalized. If any of these conditions are not met, the loop will not be marked as lower bound normalized.

modifyLowerBound(LoopData loop, Expression lowerBound)

1. loop.LowerBound←lowerBound
2. if (loop.LowerBound==0) && (loop.Guard !=NULL) && (loop.BumpNormalized) then
   a. loop.LowerBoundNormalized←TRUE
3. else
   a. loop.LowerBoundNormalized←FALSE
Step 1 sets the lower bound of the loop to be the specified expression. Step 2 compares the integer value of the specified lower bound with zero and the loop's guard and whether the loop's CIV is incremented by 1 (BumpNormalized). If all of these conditions are true, the loop is marked as LowerBoundNormalized. If any of these conditions is false, the loop is not marked as LowerBoundNormalized.
   modifyUpperBound—Modify the upper bound expression in the latch branch.
   Parameters:

loopData—A LoopData recorded for the loop.

upperBound—an upper bound expression. The generated latch branch would be:

if (IV<upperBound) goto loopLabel;

modifyUpperBound(LoopData loop, Expression upperBound)

1. loop.UpperBound←upperBound
Step 1 sets the upper bound of the specified loop to the specified expression.
   modifyGuard—Modify the guard expression for a guarded loop.
   Parameters:

loopData—A LoopData recorded for the loop.

guardExpr—a guard expression. The generated code would be:

if (!guardExpr) goto guardLabel;

modifyGuard(LoopData loop, Expression guardExpr)

1. loop.Guard←guardExpr
Step 1 modifies the guard of the specified loop to the specified guard expression.
   modifyBump—Modify the bump for a loop that contains a “bumper” (induction variable increment).
   Parameters:
loopData—A LoopData recorded for the loop.
bump—A bump expression that will be added to the induction variable on every iteration. Note that if bump is 1, the loop is marked as BumpNormalized. If the loop is BumpNormalized, has a guard and a lower bound of 0, the loop is marked as lower bound normalized.
   modifyBump(LoopData loop, Expression bump)
1. loop.SetBumpExpr←bump
2. if (bump.Isone) then
   a. loop.BumpNormalized←TRUE
3. else
   a. loop.BumpNormalized←FALSE
4. if (loop.BumpNormalized && (loop.Guard NULL) && (loop.LowerBound==0))
   a. loop.LowerBoundNormalized←TRUE
5. else
   a. loop.LowerBoundNormalized←FALSE
Step 1 sets the bump expression for the loop to the specified expression. Step 2 determines if the bump of the loop is one. If it is, the loop is marked as bump normalized (Step 2a). If it is not, the loop is marked as not bump normalized (Step 3a). Step 4 determines if all of the conditions for lower bound normalized (described above) are met. If they are, the loop is marked as lower bound normalized (Step 4a). If they are not, the loop is marked as not lower bound normalized (Step 5a).
   foldGuard—Try to fold the guard of the given loop.

If the guard expression can be computed at compile time, then this method will try to fold the guard. Uses the LoopData object to locate the guard branch, and the foldBranch method (below) to fold the guard branch.

foldGuard(LoopData loop)
1. foldBranch(loop.Guard, loop.GuardBranchTarget)
Step 1 calls the foldBranch method (described below), supplying the guard and the matching branch target (location where the branch jumps to if taken).
   foldBranch—Try to fold a branch.

If the branch expression can be computed at compile time, then this method will try to fold the branch.

foldBranch(Expression branch, Statement branchTarget)
1. branchResult←ComputeBranch(branch)
2. if (branchResult==TRUE)
   a. branch←NOOP
   b. Remove branchTarget
3. else if (branchResult==FALSE)
   a. branch←Unconditionaljump(branchTarget)
Step 1 attempts to compute the branch result. This computation can have 3 possible return values: TRUE, FALSE and UNSUCCESSFUL. If the branch was computed successfully, and it evaluates to TRUE (i.e. the statements between the branch and the branch target are executed) then the branch is transformed into a NOOP instruction, and the branch target is removed (Steps 2, 2a and 2b). If the branch is successfully computed and evaluates to FALSE (i.e. the statements between the branch and the branch target are never executed) the branch is transformed into an unconditional jump to the branch target (Steps 3 and 3a). This unconditional jump will later be removed as dead code. If the branch could not be computed, no changes are made.
   Expresstion Manipulation and Analysis Tool
   searchExpression—Searches for occurrences of a subexpression within an expression.

searchExpression(Expression expr, Expression subExpr)
1. searchPattern(expr, subExpr)
Step 1 uses the searchPattern method (described below) to find occurrences of subExpr in expr.
   searchAndReplaceExpression—Searches and replaces occurrences of a subexpression with a new subexpresssion within an expression.

searchAndReplaceExpression(Expression subExpr, Expression replaceExpr, Expression searchExpr)
1. searchAndTransformPattern(what, with, where)
Step 1 uses the searchAndTransformPattern method (described below) to replace occurrences of subExpr with replaceExpr in searchExpr.
   searchAndReplaceExpressionInCode—Performs searchAndReplaceExpression on a section of code.

searchAndReplaceExpressionInCode(Expression subExpr, Expression replaceExpr, Statement startStmt, Statement endStmt)
1. currStmt←startStmt
2. while (currStmt !=endStmt.NextStatement)
   a. currExpr←currStmt.Expression
   b. searchAndReplaceExpressionInCode(subExpr, replaceExpr, currExpr)
Step 1 initializes the current statement to be the first statement to search. Step 2 traverses through all statements from the start statement to the end statement inclusively. For each statement, the associated expression is obtained in Step 2a. The searchAndReplaceExpression (described above) is called, passing in the specific subexpression, replace expression and the current expression.
   searchAndReplaceSymbol—Searches and replaces symbols in an expression.

searchAndReplaceSymbol(Symbol searchsymbol, Symbol replacesymbol, Expression searchExpr)
1. for each Symbol sym in searchExpr
   a. if (sym==searchsymbol)
      i. sym←replaceSymbol
Step 1 goes through each symbol in the provided search expression. For each symbol, it is compared to the specified search symbol to look for. If sym is equal to the search symbol it is replaced with the specified replace symbol (Steps a and i).
   searchAndReplaceSymbolInCode—Performs searchAndReplaceSymbol on a section of code.

searchAndReplaceSymbolInCode(searchSymbol, replacesymbol, Statement firstStatement, Statement lastStatement)
1. currStmt←firstStatement
2. while (currStmt !=lastStatement.NextStatement)
   a. expression←currStmt.Expression
   b. searchAndReplaceSymbol(searchSymbol, replacesymbol, expession)
Step 1 assigns the current statement to the first statement to be searched. Step 2 traverses through all of the statements to be searched. For each statement, the expression is obtained and searchAndReplaceSymbol is used to replace uses of the search symbol with the replace symbol in the expression.
   searchPattern—Performs a recursive pattern search on an expression using expression matching transformation framework (EMTF) patterns that are used for searching and transforming patterns in the intermediate language.

searchPattern(Expression expr, Expression searchExpr)
1. match(expr, searchExpr)
Step 1 uses the match functionality of the EMTF framework to identify all occurrences of the search expression in expression.
   searchAndTransformPattern—Performs a recursive pattern transformation on an expression using EMTF patterns.

searchAndTransformPattern(EMTFPattern pattern, Expression expr)
1. newExpr←transform(pattern, expr)
2. return newExpr

The original expression is transformed based on the pattern specified in pattern.

searchAndTransformPatternInCode—Performs a recursive pattern transformation on a section of code.

searchAndTransformPatternInCode(EMTFPattern searchpattern, Statement startStmt, Statement endStmt)
1. currStmt←startStmt
2. while (currStmt !=endStmt->NextStatement)
   a. currExpression←currStmt.Expression
   b. searchAndTransformPattern(searchPattern, currExpression)
Step 1 initializes the current statement to be the specified start statement. Step 2 traverses every statement between the specified start and end statements inclusive. For each statement, the associated expression is obtained (Step 2a) and the searchAndTransformPattern function is used to transform the expression.
   Loop Analysis Tools
   getOuterNests—Collect a list of the outer loop nests in a procedure.

getOuterNests(Procedure proc)
1. outerNestList←Empty
2. for each LoopData loop in proc
   a. if (loop.NestLevel==0)
      i. outerNestList.Add(loop)
3. return outerNestList
Step 1 creates and initializes a new list to hold the loops at the outermost nest level. Each loop in the specified procedure is then analyzed. If the nest level of the loop is zero, it is considered an outermost nest and added to the list. Step 3 returns the list of outer most loops.
   countInnerMostLoopStatements—Count statements in the loop that are not loop control or bumper statements.

countInnerMostLoopStatements(LoopData loop)
1. firstStmt←loop.FirstStatement
2. lastStmt←loop.LastStatement
3. stmtCount←0
4. while (firstStmt !=laststmt)
   a. stmtCount +=1
   b. firstStmt=firstStmt.NextStatement
5. stmtCount +=1
6. return stmtCount
Steps 1 and 2 find the first and last statements in the loop. These statements will not be the guard of the loop, or the statement that increments the induction variable (the bumper). Step 3 initializes the statement count to 0. Step 4 searches the statement list, starting at the first statement in the loop and ending with the last statement. For each statement in the list, the statement count is incremented (Step 4a). The statement count is incremented one last time in Step 5 (to account for the case when firstStmt==lastStmt). Finally, the statement count is returned.
   countExecutableStatements—Count executable statements in a section of code.

countExecutableStatements(Statement startStmt, Statement endStmt)
1. exprCount←0
2. currStmt←startStmt
3. while (currStmt !=endStmt.NextStatement)
   a. currExpr←currStmt.Expression
   b. if currExpr.IsExecutable
      i. exprcount +=1
4. return exprCount
Step 1 initializes the counter to record the number of executable expressions to zero. Step 2 initializes the current statement to the start statement. Step 3 traverses all statements from the start statement to the end statement inclusively. Step 3a obtains the expression associated with the current statement. If the expression is marked as executable (Step 3b), the expression count is incremented by 1 (Step 3bᵢ). If it is not an executable expression, then the expression count is not incremented. The total number of executable expressions is returned in Step 4.
   isSingleBlockLoop—Returns true if-and-only-if the given innermost loop's body is also a single block loop (contains no branches).

isSingleBlockLoop(LoopData loop)
1. currentStatement←loop.FirstStatement
2. lastStatement←loop.LastStatement
3. while (currentStatement !=lastStatement)
   a. if currentStatement.IsBranch
      i. return FALSE
   b. currentStatement←currentStatement.NextStatement
4. return not currentStatement.IsBranch
Step 1 initializes the current statement to be the first statement of the specified loop. Step 2 initializes the last statement to be the last statement of the specified loop. Step 3 iterates through each statement in the loop. If a statement is found that is a branch, FALSE is returned (Step 3aᵢ). If none of the statements were a branch statement, Step 4 is executed. This checks to see whether the last statement is a branch. If it is, FALSE is returned. If it is not a branch, TRUE is returned.
   findJoiningLabel—Find the joining label for a branch statement.

findJoiningLabel(Statement branchStmt, Statement searchTo)
1. targetLabelId←branchStmt.TargetLabelId
2. currStmt←branchStmt.NextStatement
3. while (currStmt !=searchTo.NextStatement)
   a. if (currStmt.IsLabel) and (getLabelId(currStmt)==targetLabelId)
   b. return currStmt
4. return NULL
Step 1 gets the ID of the specified branch target. Step 2 initializes the current statement used for searching through the statements. Step 3 searches through statements, starting with the statement immediately following the branch statement and ending after the searchTo target has been analyzed. If the current statement is a label and the ID of the label is the same as the target ID of the specified branch, the current statement is returned. If the branch target label could not be found, NULL is returned (Step 4).
   getLabelId—Compute the label number of a label statement.

getLabelId(Statement labelStmt)
1. return labelStmt.Id
Step 1 gets the associated ID for the specified label statement.
   computeArticulationSet—Compute the set of nodes in a loop's articulation set—applies to innermost loops only. The articulation set of a loop contains the basic blocks that post-dominate the loop header. It is used to ensure the correctness of an optimization.

computeArticulationSet(LoopData loop)
1. articulationSet←empty
2. basicBlockList←loop.BasicBlocks
3. header←loop.Header
4. for each BasicBlock bb in basicBlockList
   a. if bb.PostDominates(header)
      i. articulationSet.Add(bb)
5. return articulationSet
Step 1 creates an empty list that will contain the articulation set of the specified loop. Step 2 creates a list of all basic blocks in the specified loop. Step 3 retrieves the loop header from the specified loop data object. Step 4 searches each basic block in the list. For each basic block, if it post-dominates the loop header, it is added to the articulation set (Step 4aᵢ). Step 5 returns the articulation set.
   computeWhirlSet—Compute the set of nodes in a loop's whirl set—applies to innermost loops only. The whirl set of a loop contains all of the basic blocks that are executed on every iteration of the loop (i.e. the basic blocks that dominate the latch branch). It is used to predict the profitability of a loop optimization.

computeWhirlSet(LoopData loop)
1. whirlSet←empty
2. basicBlockList←loop.BasicBlocks
3. latch←loop.Latch
4. for each BasicBlock bb in basicBlockList
   a. if bb.Dominates(latch)
      i. whirlSet.Add(bb)
5. return whirlSet
Step 1 creates an empty list that will contain the whirl set of the specified loop. Step 2 creates a list of basic blocks that are contained in the specified loop. Step 3 retrieves the loop's latch from the provided loop data object. Step 4 searches each basic block in the loop. For each basic block, if it dominates the loop's latch, it is added to the whirl set (Step 4aᵢ). The whirl set is returned in Step 5.
   replaceExpressionRoot—Replace the expression root of the given statement, and update call graph when necessary.

replaceExpressionRoot(Statement stmt, Expression newExpr)
1. oldExp←stmt.Expression
2. if (newExpr.IsCall or oldExpr.IsCall)
   a. for each Call c in oldExpr
      i. Remove(c)
   b. stmt.Expression←newExpr
   c. for each Call c in newExpr
      i. Add(c)
3. else
   a. stmt.Expression←newExpr
4. return
Step 1 gets the old expression from the specified statement. Step 2 determines if either the old expression or the new expression contain any calls. If either of them contain calls, the call graph must be updated as the new expression is set in the statement. Step 2a removes all calls (if any) associated with the old expression from the call graph. Step 2b sets the expression in the specified statement to the new expression. Step 2c adds any call edges in the new expression to the call graph. If neither the old expression nor the new expression contain calls, the statement can simply be updated, using the new expression (Step 3a).
   approximateCodeSize—Approximate code size for a sequence of statements.

approximateCodeSize(Statement startStmt, Statement endStmt)
1. codeSize←0
2. currStmt←startStmt
3. while (currStmt !=endStmt->NextStatement)
   a. count +=currStmt.Expression.ApproximateCodeSize
4. return codesize
Step 1 initializes the approximate code size to 0. Step 2 initializes the current statement to begin at the start statement. Step 3 iterates over statements, starting at the start statement and finishing with the end statement inclusively. The expression associated with each statement has an approximated code size, which is added to the total code size estimate (Step 3a). Step 4 returns the approximated code size.
   Other Tools
   reportLoopOptimizationOpportunity—Print a message reporting a found optimization opportunity.

This method will print a message detailing the loop, line number, procedure, opportunity, etc.

reportLoopOptimizationOpportunity(LoopData loop, String details, Output stream)
1. stream.Print(“Found ”)
2. stream.Print(details)
3. stream.Print(“in loop on line”)
4. stream.Print(loop.LineNumber)
5. stream.Print(“Details: ”)
6. stream.Print(loop)
Steps 1 through 6 show an example of relevant information that could be printed to the specified output stream regarding a loop.
   replicateCode—Replicate a section of code to a given position in the control flow.

Given a statement map (i.e. a hash table that associates specific statements with locations), replicatecode will update the map creating bidirectional bindings between old statement pointers and new statement pointer. This method can be used to implement replicateLoop, by adding the statement pointer members of the LoopData object into a statement map, replicating the loop code, and then using the map to create a new LoopData object for the replicated loop.

replicateCode(HashTable statements, Statement pos)
1. currPos←pos
2. for each Statement stmt in statements
   a. newStmt←Copy(stmt)
   b. statements.Update(stmt,newStmt)
   c. newStmt.NextStatement←currPos.NextStatement
   d. currPos.NextStatement.PreviousStatement←newStmt
   e. currPos.NextStatement←newStmt
   f. newStmt.PreviousStatement←currPos
   g. currPos←newStmt
Step 1 initializes the current position marker to the specified location for the replicated statements. Step 2 goes through each statement in the hash table. For each statement, a copy is made and assigned to newPos (Step 2a). Bidirectional bindings between the current statement and the new statement are done in Step 2b. Steps 2c to 2f link the new statement into the statement list, immediately after the current position. The current position is updated to the new statement in Step 2g.
   Creating Loop Optimization Transformations Using the Loop Tools

Now that the low-level tools themselves have been defined, the following representative examples show how such low-level tools/commands can be used to create various high-level optimization transformations.

Loop Unswitching—Moving a loop invariant condition out of a loop

Taking the invariant condition out of the loop requires creating two versions of the loop—one where the condition defaults to fall-through and the other where it defaults to taken. Using the Loop Tools, once the condition expression is identified, we can simply use the versionLoop tool, supplying the condition expression. A later (independent) optimization transformation that folds branches should be able to take care of folding the branches on this condition in the two versions of the loop (since it can assume always taken or always fall-through based on control flow).

UnswitchLoop(LoopData loop)
1. currStmt←loop.FirstStatement
2. laststmt←loop.LastStatement->NextStatement
3. conditionStatement←NULL
4. while (currStmt !=lastStmt)
   a. if ((currStmt.IsBranch) && currStmt.IsLoopInvariant(loop))
      i. conditionStatement←currStmt
      ii. currStmt←lastStatement.NextStatement
   b. else
      i. currStmt←currStmt.NextStatement
5. if (conditionStatement !=NULL)
   a. versionLoop(loop, conditionStatement)
   b. return TRUE
6. return FALSE
Step 1 retrieves the first statement in the loop. Step 2 retrieves the statement after the last statement in the loop. Step 3 initializes the condition statement to NULL. Step 4 traverses through all statements in the loop. If a condition statement is found that is invariant to the specified loop, the condition statement is recorded and the search terminates (Steps 4aᵢ and 4aᵢᵢ). If the current statement is not a loop invariant branch, the search moves to the next statement (Step 4bᵢ). When the search has terminated, if the condition statement is NULL, no loop invariant branch was found in the loop and FALSE is returned. If a condition statement was found, the versionLoop function is used to create separate versions of the loop, guarded by the condition statement. A later optimization that tracks condition values across branch statements can then remove the loop invariant condition from each of the loops.
   Loop Peeling—Taking a few iterations off the beginning of the iteration space, or off the end of the iteration.

To implement Loop Peeling of k iterations from the beginning of the iteration space, we can use the splitLoop tool providing k as the split point (splitLoop takes care of peeling the prolog and epilog of the loop—using the peelprolog and peelEpilog tools respectively, and guarding the split loops in such a way that together they will always perform the original number of iterations). If k and the loop's upper bound are compile-time known, a later (independent) optimization transformation that completely unrolls short loops can do that for the peeled iterations (when k or the upper bound or compile-time unknown we should not complete unroll anyway).

PeelLoop(LoopData loop, Integer numiterations)
1.loopIV←loop.CIV
2. splitExpression←if (loopIV<numiterations)
3. splitLoop(loop, splitExpression)
Step 1 retrieves the induction variable of the loop from the loop data object. Step 2 creates a split point expression using the induction variable and the specified number of iterations to be peeled. Finally, the splitLoop function is used to peel the desired number of iterations from the original loop.
   Loop Fusion—Fusing two loops with a matching iteration space into a single loop.

If the two loops use different Induction Variables, we can use the searchAndReplaceSymbolInCode tool make the two loops use the same Induction Variable. Then we can use the Unlink tool to unlink, say, the second loop from the control flow, and using the LoopData of the first loop locate the insertion point (BodyEnd—before the loop's bumper statement), and then use that point with the Link tool to insert the second loop at the end of the first's body. Then by using the

removeLoopControlStructure on the loop data of the second loop, we convert its code into a part of the first loop's body.

FuseLoops(LoopData firstLoop, LoopData secondLoop)
1. firstLoopIV←firstLoop.CIV
2. secondLoopIV←secondLoop.CIV
3. searchAndReplaceSymbolInCode(secondLoopIV, firstLoopIV, secondLoop.FirstStatement, secondLoop.LastStatement)
4. Unlink(secondLoop)
5. Link(secondLoop, firstLoop.BodyEnd)
6. removeLoopControlStructure(secondLoop)
Steps 1 and 2 retrieve the induction variables from the first and second loops respectively. Step 3 uses the searchAndReplaceSymbolInCode function to replace all occurrences of the second loop's induction variable with the first loop's induction variable in the second loop. The second loop is then removed from the statement list and added to the statement list immediately after the body of the first loop (Steps 4 and 5). Finally, the removeLoopControlStructure function is used to remove all loop specific control code from the second loop.
   Strip-Mining—Dividing a loop's iteration space into fixed length strips.

Given a strip length, the blockLoop tool can be used to create the effect of strip-mining, giving it the loop to strip-mine as both the “which” and the “where” parameters.

StripMineLoop(LoopData loop, Integer stripLength)
1. blockLoop(loop, loop, stripLength)
   Loop Tiling—Dividing a loop nest's iteration space into smaller multi-dimensional tiles.

Multiple uses of blockLoop (blocking the tiling candidate loops in the nest at some outer level) creates the loop tiling effect.

Loop Unrolling—Unroll a loop to execute uf iterations at a time (uf being the unroll factor).

Loop unrolling usually requires a residue loop (if we can't figure out whether the loop count divides by the unroll factor), and a main unrolled nest. To perform loop unrolling with loop tools, assuming normalized loops (i.e. lower bound=0, bumper=1, loop invariant upper bound—which is also equal to the loop iteration count), we can use the splitLoop tool, splitting the iteration space at MOD(upper bound, uf), yielding a residue loop and a main nest (second loop). Using the loop data that we get from splitLoop, we determine the section of code for the loop body (mBodyBegin, mBodyEnd) and use replicateCode to replicate the code uf-1 times. For each replica k from 1 to uf-1 we use searchAndTransformPatternInCode to transform the loads of the induction variable into add of the induction variable and k. We can then use the modifyBump tool to modify the bumper of the unrolled loop from 1 to uf.

UnrollLoop(LoopData loop, Integer unrollFactor)
1. splitpoint←MOD(loop.UpperBound, unrollFactor)
2. mainLoop←splitLoop(loop, splitpoint)
3. offset←1
4. replicateStart←mainLoop.BodyBegin
5. replicateEnd←mainLoop.BodyEnd
6. newCodePos←mainLoop.BodyEnd.PreviousStatement
7. loopIV←loop.CIV
8. while (offset<unrollFactor)
   a. replicateCode(replicateStart, replicateEnd, newCodePos)
   b. searchAndTransformPatternInCode(loopIV, loopIV+offset, newCodePos, mainLoop.BodyEnd)
   c. newCodePos←mainLoop.BodyEnd.PreviousStatement
   d. offset +=1
9. modifyBump(mainLoop, unrollFactor)
Step 1 creates a split point expression that computes the upper bound of the loop modulo the unroll factor. Step 2 splits the original loop in two, creating the main loop and leaving the original loop as the residual. Step 3 initializes the offset to 1. Steps 4 and 5 record the first and last statements to be replicated. Step 6 records the position in the statement list where the replicated statements will be placed. Step 7 retrieves the induction variable of the loop. Step 8 creates unrollFactor-1 copies of the original loop body. In each copy, the uses of the induction variable are replaced with uses of the induction variable plus the current offset (Step 8b). The position where the next replicated section of code will be placed is updated in Step 8c. Finally, the bump statement for new loop is modified to increment by unroll factor.
   Outer loop unroll-and-jam—Unrolling an outer loop and fusing the resulting inner loops to make use of self-temporal data re-use.

Similarly to loop unrolling, we can split the outer loop using splitLoop, replicate the innermost loop body using replicateCode and use searchAndTransformPaternInCode to transform references to the outer loop induction variable to adds with the replica number (see Loop Unrolling above for more details). Finally, we modify the bump of the outer loop using modifyBump to increment by the unroll factor.

OuterLoopUnrollAndJam(LoopData outerLoop, LoopData innerLoop, Integer unrollFactor)
1. splitPoint←MOD(outerLoop.UpperBound, unrollFactor)
2. mainLoop←splitLoop(outerLoop, splitpoint)
3. offset←1
4. replicateStart←innerLoop.BodyBegin
5. replicateEnd←innerLoop.BodyEnd
6. newCodePos←innerLoop.BodyEnd.PreviousStatement
7. loopIV←outerLoop.CIV
8. while (offset<unrollFactor)
   a. replicateCode(replicateStart, replicateEnd, newCodePos)
   b. searchAndTransformPatternInCode(loopIV, loopIV+offset, newCodePos, innerLoop.BodyEnd)
   c. newCodePos←innerLoop.BodyEnd.PreviousStatement
   d. offset +=1
9. modifyBump(mainLoop, unrollFactor)
Step 1 computes the split point using the upper bound of the outer loop modulo the unroll factor. Step 2 splits the outer loop creating the mainLoop and leaving the original outer loop as the residual. Step 3 initializes the offset to 1. Steps 4 and 5 record the start and end statements to replicate. Step 6 records the location where the replicated statements will be placed. Step 7 retrieves the induction variable from the outer loop. Step 8 replicates the body of the inner loop unrollFactor-1 times. Each time the inner loop is replicated, uses of the outer loop's induction variable are increased by the current offset (Step 8b). The position that the next replicated loop body will be placed at is recorded in Step 8c. The offset is incremented by 1 in Step 8. Finally, the bump of the outer loop is modified to increase by unrollFactor in Step 9.
   Index-Set Splitting—Split an index range of a loop into consecutive sub-ranges.

Using multiple invocations of splitLoop, we can divide the iteration space of the original loop into sub-ranges. When the order of split points is not known at compile time, we either need to split every split loop with any additional split point (to maintain correctness) or create a “smarter” set of split points based on the technique described in the above referenced patent application entitled “Generalized Index Set Splitting in Software Loops”. Generally, Index-Set Splitting is a loop optimization that removes loop variant branches from inside a loop body. This is achieved by creating two, or more, loops whose bounds are based on the value of the loop variant branch test. The following example shows a loop containing a loop variant branch:

```
DO I=1,100
  IF (I < 50)
    code A
  ELSE
      code B
END DO
```

After Index-Set Splitting has been applied, the following two loops are created:

```
DO I=1,49
  code A
END DO
DO I=50,100
  code B
ENDDO
```

Special care must be taken when the value of the guard is not known at compile time (i.e. a guard of the form I<N, where N is not known at compile time), as described in the above referenced Index-Set Splitting patent application.

Loop Versioning—Creating two versions of a loop switched by a condition.

Loopversioning(LoopData loop, Statement condition)
1. versionLoop(loop, condition)

This is a simple use of the versionLoop tool.

Complete Loop Unrolling—Unrolling a loop with a fixed small iteration count, converting it to a non-loop.

Using replicateCode and searchAndTransformPatternInCode, we can create and modify the replicas accordingly. Then, by using removeLoopControlStructure, we can convert the resulting loop into a non loop.

CompleteUnrollLoop(LoopData loop)
1. numIterations←loop.UpperBound
2. currIteration←1
3. newCodePos←loop.BodyEnd.PreviousStatement
4. loopIV←loop.CIV
5. replicateStart←loop.BodyBegin
6. replicateStart←loop.BodyEnd
7. while (currIteration<numIterations)
   a. replicateCode(replicateStart, replicateEnd, newCodePos)
   b. searchAndTransformPatternInCode(loopIV, loopIV+currIteration, newCodePos, loop.BodyEnd)
   c. newCodePos←loop.BodyEnd.PreviousStatement
   d. currIteration +=1
8. removeLoopControlStructure(loop)
Step 1 obtains the upper bound for the loop. The value of the upper bound must be known at compile time in order to completely unroll the loop. Step 2 initializes the current iteration to 1. Step 3 initializes the location where the replicated code will be placed. Step 4 retrieves the loop's induction variable. Steps 5 and 6 obtain the start and end of the loop body to be replicated. Step 7 replicates the loop body numIterations-1 times. The uses of the induction variable are modified in every replicated statement to use an offset based on the current iteration (Step 7b). The position where the next replicated section of code will be placed is set in Step 7c. The current iteration is incremented in Step 7d. Finally, all loop control structures are removed in Step 8.
   Predictive Commoning—Reusing computations across loop iterations.

Predictive commoning is a loop optimization that identifies accesses to memory elements that are required in immediately subsequent iterations of the loop. These elements are identified, and stored in registers thereby reducing the number of redundant memory loads required in subsequent iterations of the loop. The previous identified patent application entitled “A Method and System for Automatic Second-Order Predictive Commoning” uses the Loop Tools described herein to perform the transformation. The unrolling effect is achieved similarly to the description of the Loop Unrolling above, while the transformations of computations with scalars is done using searchAndTransformInCode. Second-Order Predictive Commoning uses the following tools as part of its analysis and transformation: searchPattern, computeArticulationSet, searchAndTransformPattern, searchAndTransformPatternInCode, approximateCodeSize, versionLoop, splitLoop, replaceExpressionRoot, and replicateCode.

The following code demonstrates a loop containing a predictive commoning opportunity:

DO I=2,N−1
A(I) = C1*B(I−1) + C2*B(I) + C3*B(I+1)
END DO

After predictive commoning, the loop is transformed to:

```
R1=B(1)
R2=B(2)
DO I=2,N−1
      R3 = B(I+1)
      A(I) = C1*R1 + C2*R2 + C3*R3
      R1 = R2
      R2 = R3
END DO
```

### CONCLUSION

Beyond the benefits of having the loop manipulation code organized in a single repository of low-level loop optimization commands, making it easy to maintain/support and reducing the number of defects, the Loop Tools as described herein also enable a higher-level view of loop optimization transformation, allowing the loop optimizer developers to think about loop optimization at a higher abstraction level, resulting in new a more powerful optimizations. In addition, the Loop Tools described herein update LoopData objects when transforming loops, and thus the data contained therein remains valid and consistent even though the flow graph is no longer valid.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communications links, wired or wireless communications links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A hierarchical loop optimization system, comprising:
a first set of low level loop tools used for optimizing code execution flow in a machine executable program; and
a second set of high level loop optimization techniques used for optimizing code execution flow in the machine executable program, wherein each of the high level loop optimization techniques comprises at least one of the low level loop tools.

2. The system of claim 1, further comprising a plurality of loop data objects, wherein each of the loop data objects maintains data pertaining to a loop, said loop data objects being accessed when transforming loops during loop optimization.

3. The system of claim 1, wherein at least one of the high level loop optimization techniques comprises at least two of the low level loop tools.

4. The system of claim 1, wherein the first set of low level loop tools comprises a replicate code tool which replicates a section of code, and wherein the second set of high level loop optimization techniques comprises a loop unrolling tool that converts a loop to a non-loop using the replicate code tool.

5. The system of claim 1, wherein the first set of low level loop tools comprises a block loop tool which blocks a loop using a given blocking factor, and wherein the second set of high level loop optimization techniques comprises a strip mining tool that divides a loop's iteration space into fixed length strips using the block loop tool.

6. The system of claim 5, wherein the block loop tool uses at least two parameters when invoked, including a pointer to a first loop data object maintained for a loop to be blocked, and a stripe size blocking factor.

7. A method for optimizing machine code, comprising the steps of:
generating a set of low-level loop optimization commands from a set of high-level loop optimization commands; and
using said set of low-level loop optimization commands to optimize the machine code.

8. The method of claim 7, wherein said using step accesses a loop data object associated with a loop in the machine code.

9. The method of claim 7, wherein at least some of the low-level loop optimization commands each have at least one loop parameter that is passed to them when individually invoked, and wherein the loop parameter is a loop data object that contains data pertaining to a loop.

10. The method of claim 7, wherein at least some of the high-level loop optimization commands each have at least one loop parameter that is passed to them when individually invoked, and wherein the loop parameter is a loop data object that contains data pertaining to a loop.

11. The method of claim 7, wherein said set of high-level loop optimization commands comprises a high-level command to divide a loop's iteration space into fixed length strips.

12. The method of claim 11, wherein a low-level loop optimization command generated from the high-level command comprises a block loop command which blocks the loop using a given blocking factor.

13. A method for optimizing machine code, comprising the steps of:
using a loop data object to maintain data regarding a loop in the machine code when transforming the loop during loop optimization such that the data regarding the loop remains valid even though a flow graph for the loop is invalidated as part of the loop transformation.

14. The method of claim 13, further comprising a step of:
invoking a tool to replicate the loop in the machine code, wherein the tool provides a second loop data object for the replicated loop, said second loop data object comprising pointers for all recorded statement pointers in a first loop data object associated with the loop, wherein the pointers point to corresponding statements in the replicated loop.

15. A system for optimizing machine code, comprising:
means for generating a set of low-level loop optimization commands from a set of high-level loop optimization commands; and
means for using said set of low-level loop optimization commands to optimize the machine code.

16. The system of claim 15, wherein said using step accesses a loop data object associated with a loop in the machine code.

17. The system of claim 15, wherein at least some of the low-level loop optimization commands each have at least one loop parameter that is passed to them when individually invoked, and wherein the loop parameter is a loop data object that contains data pertaining to a loop.

18. The system of claim 15, wherein at least some of the high-level loop optimization commands each have at least one loop parameter that is passed to them when individually invoked, and wherein the loop parameter is a loop data object that contains data pertaining to a loop.

19. The system of claim 15, wherein said set of high-level loop optimization commands comprises a high-level command to divide a loop's iteration space into fixed length strips.

20. The system of claim 19, wherein a low-level loop optimization command generated from the high-level command comprises a block loop command which blocks the loop using a given blocking factor.

21. A system for optimizing machine code, comprising:
means for accessing the machine code; and
means for using a loop data object to maintain data regarding a loop in the machine code when transforming the loop during loop optimization such that the data regarding the loop remains valid even though a flow graph for the loop is invalidated as part of the loop transformation.

22. The system of claim 21, further comprising:
means for invoking a tool to replicate the loop in the machine executable code, wherein the tool provides a second loop data object for the replicated loop, said second loop data object comprising pointers for all recorded statement pointers in a first loop data object for the loop, wherein the pointers point to corresponding statements in the replicated loop.

23. A computer program product on a computer accessible media, said computer program product comprising instructions for optimizing machine code, said instructions comprising:
instruction means for generating a set of low-level loop optimization commands from a set of high-level loop optimization commands; and
instruction means for using said set of low-level loop optimization commands to optimize the machine code.

24. A computer program product on a computer accessible media, said computer program product comprising instructions for optimizing machine code, said instructions comprising:
instruction means for using a loop data object to maintain data regarding a loop in the machine code when transforming the loop during loop optimization such that the data regarding the loop remains valid even though a flow graph for the loop is invalidated as part of the loop transformation.
